(19) United States
(12) Patent Application Publication
(10) Pub. No.: US 2013/0300213 A1
(43) Pub. Date: Nov. 14, 2013

(54) IDENTIFICATION CIRCUIT

(71) Applicant: HAI-QING ZHOU, Shenzhen City (CN)

(72) Inventor: HAI-QING ZHOU, Shenzhen City (CN)

(73) Assignees: HON HAI PRECISION INDUSTRY CO., LTD., Tu-Cheng (TW); HONG FU JIN PRECISION INDUSTRY (Shenzhen) CO., LTD, Shenzhen City (CN)

(21) Appl. No.: 13/592,427

(22) Filed: Aug. 23, 2012

(30) Foreign Application Priority Data
May 9, 2012 (CN) 201210141171.7

(51) Int. Cl. H01H 47/00

(52) U.S. Cl. 307/115

(57) ABSTRACT

An identification circuit is connected between a universal serial bus (USB) interface, and each of a controller and a power management unit (PMU). The identification circuit includes first to fourth electronic switches. When a power adapter is connected to the USB interface, the negative data pin of the USB interface is floating. The first and fourth electronic switches are turned off. The second and third electronic switches are turned on. Power from the power adapter is transmitted to the second power pin of the PMU. When the USB interface is connected to a computer, the negative data pin of the USB interface outputs a low level signal. The first and fourth electronic switches are turned on. The second and third electronic switches are turned off. Power from the computer is transmitted to an electronic device with the USB interface.

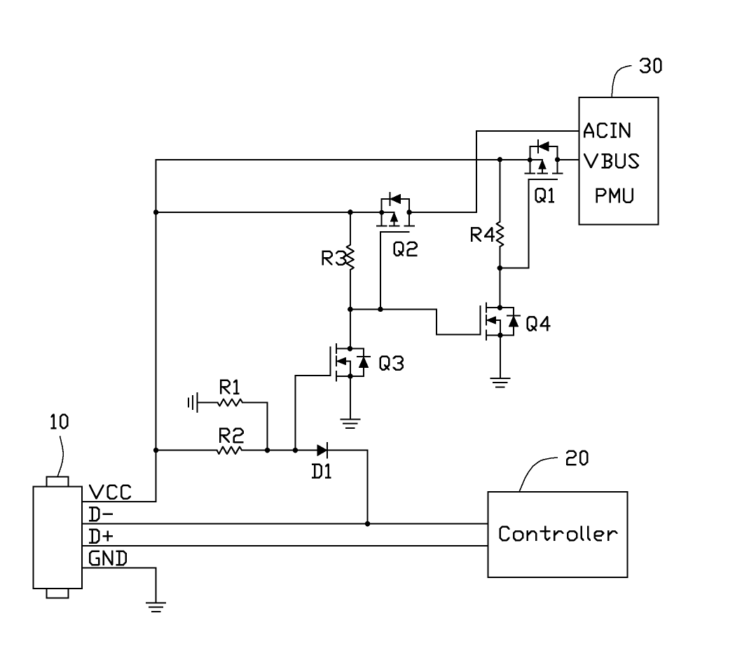

### BACKGROUND

1. Technical Field

The present disclosure relates to an identification circuit for universal serial bus (USB) interfaces.

2. Description of Related Art

Some electronic devices can be charged through their USB interface(s). The power to charge the electronic device may be supplied by another electronic device, such as a computer, or directly from a regular power outlet using a USB adapter. When the electronic device is connected to a computer through the USB cable, the electronic device may exchange data with the computer. If the electronic device is unable to determine whether it is connected to a computer or to a power source, such as when connected to a power outlet, the electronic device would ignore or shut down the connected USB interface, thus the electronic device would not be charged. Therefore, a controller of the electronic device must identify whether the power source is another electronic device or a power outlet. At present, a costly special identification chip is used to identify the type of power source connected to the electronic device.

### BRIEF DESCRIPTION OF THE DRAWING

Many aspects of the embodiments can be better understood with reference to the following drawing. The components in the drawings are not necessarily drawn to scale, the emphasis instead being placed upon clearly illustrating the principles of the present embodiments. Moreover, in the drawing, like reference numerals designate corresponding parts throughout the view.

The figure is a circuit diagram of an exemplary embodiment of an identification circuit for interfaces.

### DETAILED DESCRIPTION

The disclosure, including the accompanying drawing, is illustrated by way of examples and not by way of limitation. It should be noted that references to “an” or “one” embodiment in this disclosure are not necessarily to the same embodiment, and such references mean at least one.

Referring to the figure, an identification circuit is connected between a universal serial bus (USB) interface 10, and each of a controller 20 and a power management unit (PMU) 30. An exemplary embodiment of the identification circuit includes four metal oxide semiconductor field effect transistors (MOSFETs) Q1-Q4, resistors R1-R4, and a diode D1. The MOSFETs Q1 and Q2 are p-channel MOSFETs. The MOSFETs Q3 and Q4 are n-channel MOSFETs.

A power pin VCC of the USB interface 10 is connected to sources of the MOSFETs Q1 and Q2. A negative data pin D− and a positive data pin D+ of the USB interface 10 are connected to the controller 20. A ground pin GND of the USB interface 10 is grounded. When a USB device is connected to the USB interface 10, the power pin VCC supplies power to the USB device, and the positive data pin D+ and the negative data pin D− transmit data between the USB device and the controller 20.

The negative data pin D− of the USB interface 10 is further connected to a cathode of the diode D1. An anode of the diode D1 is grounded through the resistor R1. The anode of the diode D1 is further connected to the power pin VCC of the USB interface 10 through the resistor R2. The anode of the diode D1 is further connected to a gate of the MOSFET Q3. A source of the MOSFET Q3 is grounded. A drain of the MOSFET Q3 is connected to the power pin VCC of the USB interface 10 through the resistor R3. The drain of the MOSFET Q3 is further connected to gates of the MOSFETs Q2 and Q4. A drain of the MOSFET Q2 is connected to a power pin ACIN of the PMU 30. A drain of the MOSFET Q1 is connected to a power pin VBUS of the PMU 30. A source of the MOSFET Q4 is grounded. A drain of the MOSFET Q4 is connected to a source of the MOSFET Q1 through the resistor R4. The drain of the MOSFET Q4 is further connected to a gate of the MOSFET Q1.

According to USB standards, a USB device includes a power pin, a ground pin, and two data pins. A power adapter includes a power pin and a ground pin.

When a power adapter is connected to an electronic device with the USB interface 10 through a USB cable, the negative data pin D− of the USB interface 10 is floating. At this time, a voltage received by the gate of the MOSFET Q3 is equal to a voltage which is obtained by the 3.3 volt power supply divided by the resistor R1. In other words, the voltage received by the gate of the MOSFET Q3 is regarded as a high level signal. The MOSFET Q3 is turned on. The MOSFET Q2 is turned on. As a result, power from the power adapter is transmitted to the power pin ACIN of the PMU 30 through the USB interface 10 and the MOSFET Q2, such that the electronic device is charged through the USB interface 10.

When a computer is connected to the electronic device with the USB interface 10 through the USB cable, the negative data pin D− outputs a low level signal. At this time, the diode D1 is turned on, and the MOSFET Q3 is turned off. The MOSFET Q2 is turned off. The MOSFETs Q1 and Q4 are turned on. The controller 20 determines that the USB interface 10 is connected to the computer. As a result, power from the computer is transmitted to the power pin VBUS of the PMU 30 through the MOSFET Q1 and the USB interface 10, such that the computer supplies power to the electronic device through the USB interface 10, and data can be transmitted between the computer and the electronic device through the USB interface 10.

In the embodiment, the MOSFETs Q1-Q4 function as electronic switches.

The foregoing description of the exemplary embodiments of the disclosure has been presented only for the purposes of illustration and description and is not intended to be exhaustive or to limit the disclosure to the precise forms disclosed. Many modifications and variations are possible in light of everything above. The embodiments were chosen and described in order to explain the principles of the disclosure and their practical application so as to enable others of ordinary skill in the art to utilize the disclosure and various embodiments and with various modifications as are suited to the particular use contemplated. Alternative embodiments will become apparent to those of ordinary skills in the art to which the present disclosure pertains without departing from its spirit and scope. Accordingly, the scope of the present disclosure is defined by the appended claims rather than the foregoing description and the exemplary embodiments described therein.

What is claimed is:

1. An identification circuit connected between a universal serial bus (USB) interface, and each of a controller and a power management unit (PMU), the identification circuit comprising:
first to fourth electronic switches, a power pin of the USB interface is connected to first terminals of the first and second electronic switches, a negative data pin and a positive data pin of the USB interface are connected to the controller, a ground pin of the USB interface is grounded, a control terminal of the third electronic switch is grounded through a first resistor, and is connected to the negative data pin of the USB interface, a node between the control terminal of the third electronic switch and the first resistor is connected to the power pin of the USB interface through a second resistor, a first terminal of the third electronic switch is grounded, a second terminal of the third electronic switch is connected to control terminals of the second and fourth electronic switches, the second terminal of the third electronic switch is further connected to the power pin of the USB interface through a third resistor, a first terminal of the fourth electronic switch is grounded, a second terminal of the fourth electronic switch is connected to a control terminal of the first electronic switch, a second terminal of the first electronic switch is connected to a first power pin of the PMU, a second terminal of the second electronic switch is connected to a second power pin of the PMU, the second terminal of the fourth electronic switch is further connected to the power pin of the USB interface through a fourth resistor; wherein when the control terminals of the first to fourth electronic switches receive high level signals, the first and second terminals of each of the first and second electronic switches are disconnected, and the first and second terminals of each of the third and fourth electronic switches are connected; when the control terminals of the first to fourth electronic switches receive low level signals, the first and second terminals of each of the first and second electronic switches are connected, and the first and second terminals of each of the third and fourth electronic switches are disconnected.

2. The identification circuit of claim 1, further comprising a diode, wherein an anode of the diode is connected to the control terminal of the third electronic switch, a cathode of the diode is connected to the negative pin of the USB interface.

3. The identification circuit of claim 1, wherein the first electronic switch is a p-channel metallic oxide semiconductor field effect transistor (MOSFET), a gate of the MOSFET functions as the control terminal of the first electronic switch, a source of the MOSFET functions as the first terminal of the first electronic switch, a drain of the MOSFET functions as the second terminal of the first electronic switch.

4. The identification circuit of claim 1, wherein the second electronic switch is a p-channel MOSFET, a gate of the MOSFET functions as the control terminal of the second electronic switch, a source of the MOSFET functions as the first terminal of the second electronic switch, a drain of the MOSFET functions as the second terminal of the second electronic switch.

5. The identification circuit of claim 1, wherein the third electronic switch is an n-channel MOSFET, a gate of the MOSFET functions as the control terminal of the third electronic switch, a source of the MOSFET functions as the first terminal of the third electronic switch, a drain of the MOSFET functions as the second terminal of the third electronic switch.

6. The identification circuit of claim 1, wherein the fourth electronic switch is an n-channel MOSFET, a gate of the MOSFET functions as the control terminal of the fourth electronic switch, a source of the MOSFET functions as the first terminal of the fourth electronic switch, a drain of the MOSFET functions as the second terminal of the fourth electronic switch.
